(19) United States
(12) Patent Application Publication
(10) Pub. No.: US 2015/0158187 A1
(43) Pub. Date: Jun. 11, 2015

(54) FOLDING KNIFE WITH DOUBLE DEPRESSION BLADE OPENING MECHANISM

(71) Applicant: Spyderco, Inc., Golden, CO (US)

(72) Inventor: Sal Glesser, Evergreen, CO (US)

(73) Assignee: Spyderco, Inc., Golden, CO (US)

(21) Appl. No.: 14/098,682

(22) Filed: Dec. 6, 2013

(51) Int. Cl. B26B 1/02

(52) U.S. Cl. CPC B26B 1/02

(57) ABSTRACT

A folding knife is provided that has at least two opening features on a blade of the folding knife. These opening features reduce the likelihood of injury when a user opens the folding knife and improve the effectiveness of the folding knife These opening features may be depressions, protrusions, or any other opening feature that aids the user and are positioned generally near the distal end of the blade.

### FIELD OF THE INVENTION

The present invention relates to cutting instruments and more specifically to folding knives with opening mechanisms or features that aid a user in opening folding knife blades.

### BACKGROUND OF THE INVENTION

Cutting instruments have been used for centuries by craftsmen, hunters, and others requiring a sharp cutting instrument. Pocket knives are commonly carried by sportsmen, craftsmen and other users who desire a compact, portable blade which can be safely folded and transported in a pocket or attached to a belt. More recently, fixed length knives have been replaced with popular folding knives, which generally have two positions. In an open or extended position of use, the knife cutting blade is extended to expose the blade cutting edge and permit cutting therein. In a closed position, the cutting edge of the blade is stored within a cavity or recess in the handle portion of the knife, thus preventing the blade from being exposed. While folding knives are compact and portable in a closed position, a folding knife that is difficult to open presents a host of problems.

Users carry folding knives due to their compact and portable profile, but the intended use of folding knives includes emergency situations. Sportsman, craftsman, and other users are often engaged in activities that are inherently dangerous or take the user to a location that is remote from emergency services. In these situations, an emergency can arise where the user may need to immediately use his or her folding knife and time is of the essence. In an emergency, a user needs a folding knife that is quickly and easily opened from a closed position to an open position, and preferably with one hand.

Beyond emergencies, a user needs a folding knife that is quickly and easily opened from a closed position to an open position to improve the effectiveness of the folding knife and avoid injury to himself or herself. The design of a folding knife and the configuration of its components can impede the effectiveness of the folding knife. For example, when a folding knife is in a closed position the height of the scales on the handle relative to the height of the blade may create difficulty in opening the folding knife.

Folding knives typically have a first scale and a second scale that form the handle portion of a folding knife. When the folding knife is in a closed position, the blade is stored within a cavity or recess created in part by the scales. If the scales are larger in height relative to the height of the blade, then a greater portion of the blade is stored in the cavity or recess and a lesser portion of the blade is exposed for a user to grip. A user has greater difficulty gripping a smaller area of the blade, and this creates difficulty when opening the blade.

An aspect of a folding knife that creates an increased risk of injury is resistance to opening. Often, folding knives have designs or configurations that create resistance to the motion of the blade to reduce the possibility that a folding knife will be unintentionally or accidentally opened. However, when a user attempts to open a folding knife with his or her fingernails, the resistance to opening can break, bend, or chip the user's fingernails or cause damage to the user's soft tissue.

Some folding knives utilize interference between the blade and a back spacer to create resistance, or optionally use a ball d étente. A back spacer is located between the first scale and the second scale to create depth to the cavity or recess when the blade is stored in the closed position. As a user pivots the blade from the closed position the interference between the blade and the back spacer creates friction and thus resistance. Thus, the user must exert additional effort to open the blade.

Other folding knife designs and configurations can create resistance to opening. A more complex folding knife design comprises a back spacer system that has a spring. Thus, when the user is opening the blade from the closed position, he or she must overcome the resistance created by a spring loaded system designed to prevent unintentional openings.

Likewise, scales may interfere with the blade and create resistance. The blade pivots about a pin which also secures a first scale and a second scale to the folding knife. If the pin is short in length, the first scale and second scale may interfere with the heel end of the blade. The interference causes friction as the user opens the blade from a closed position, and thus the user must exert additional effort to open the blade.

Some existing folding knives have features that aid in opening a folding knife from a closed position. For example, some folding knives have a recess located on one side of the blade. The recess allows a user to insert his or her fingernail into the recess and pivot the blade from the closed position. However, the recess has several shortcomings. Only a fingernail may access the recess which places the fingernails under strain. Also, the recess exists only on one side of the blade. Applying force to only one side of the blade places the blade in torsion. The torsion creates a non-uniform force profile on the pin which results in increased resistance to opening. The fingernail-only access to the recess and the fact that the recess exists only on one side of the blade places a user at risk of the above-mentioned injuries associated with some folding knife designs and configurations.

Further, some folding knives incorporate features that increase the costs associated with manufacturing folding knives. For example, through-holes must be drilled or punched out, and a thumb stud is an additional component that must be affixed to the blade. These features necessitate additional steps during the manufacturing process and result in increased costs.

### SUMMARY OF THE INVENTION

It is thus an aspect of embodiments of the present invention to provide a folding knife that is quickly and easily openable from a closed position to an open position. It is a further aspect of embodiments of the present invention to improve the effectiveness of the folding knife, to reduce the likelihood of injury when a user rotates a folding knife blade, and to more easily overcome the resistance required to open the folding knife blade.

One aspect of embodiments of the present invention is to provide an increase in surface area or contact area for a user's fingers to decrease the concentration of forces, stress, and strain on the user. This leads to an improved effectiveness of the folding knife and a reduced risk of injury. Some embodiments of the present invention provide opening features (also called a “opening mechanisms” herein) on the blade of the folding knife to increase the surface area or contact area between the user and the blade. The improved effectiveness includes closing a folding knife wherein an increased surface area or contact area provides greater control for a user and thus less likelihood of accidentally closing the folding knife.

It is a further aspect of embodiments of the present invention to reduce torsion on the interconnection point between the heel end of the blade and the pivot pin of the handle when a user contacts both sides of the blade of the folding knife. Opening features on the blade of the folding knife enable a user to contact both sides of the blade of the folding knife. When a user contacts both sides of the blade of the folding knife, the user creates a more uniform force profile on the interconnection point between the heel end of the blade and the pivot pin of the handle, which reduces torsion. This reduction in torsion makes it easier for the user to overcome resistance to opening the folding knife blade.

Another aspect of embodiments of the present invention is to increase the moment force about the pivot pin to help the user overcome resistance to opening the folding knife blade. When the user moves the blade of the folding knife from a closed position to an open position, the user experiences a resistance to opening the folding knife blade. Opening features that are advantageously located on the folding knife blade help the user gain more leverage about the pivot pin to help the user overcome resistance to opening the folding knife blade.

One embodiment of the present invention includes a folding knife with two opening features, where one opening feature located on one side of the blade and another opening feature is located on the other side of the blade. In a further embodiment, the first and second opening features may be depressions. In an alternative embodiment, the first and second opening features may be protrusions.

In another embodiment of the present invention, the folding knife includes more than two opening features. Additional opening features may be located on either side of the folding knife blade, and positioned proximate to a distal end of the blade or positioned more closely to the pivot point of the blade near the handle. Additional opening features may be located for a particular preference of the user, a particular use of the user, or any other arrangement of opening features that would be advantageous.

In a further embodiment of the present invention, one side of the folding knife blade may include one type of opening feature, and the other side of the folding knife blade may include a different type of opening feature. For example, one side of the folding knife blade may comprise a depression, and the other side of the folding knife blade may comprise a protrusion. This particular embodiment of the invention is not necessarily limited to two opening features.

In another embodiment of the present invention, one opening feature on one side of the folding knife blade and another opening feature on the other side of the folding knife blade are not located the approximately same distance from the distal end of the folding knife blade and the approximately same distance from the spine of the folding knife blade. The location of the opening features may suit a particular preference of the user, a particular use by the user, or any other arrangement of opening features that would be advantageous.

In a further embodiment of the present invention, the folding knife blade includes an aperture for a number of advantages. For example, the aperture may assist the user in opening the folding knife blade or give the user additional control when closing the folding knife blade.

One embodiment of the present invention includes a folding knife blade with features that are partially disposed within a cavity in a handle of the folding knife when the folding knife is in a closed position. This disposition of the opening features allows a user to press off of the handle of the folding knife instead of solely relying on manually compressing the blade of the folding knife. Thus, the blade is more quickly and easily opened, risk of injury is reduced, and the user is better able to overcome the resistance required to open the folding knife blade.

One particular embodiment of the present invention is a folding knife comprising: a blade having a first side, a second side, a spine, a distal end, a heel end, and a midline positioned approximately half-way between said distal end and said heel end; a handle having a pivot pin and a cavity, wherein said heel end of said blade is pivotally interconnected to said pivot pin, wherein said blade is movable from a closed position to an open position, and wherein said blade is at least partially disposed within said cavity when said blade is in said closed position; a first opening feature located on said first side of said blade; a second opening feature located on said second side of said blade; and wherein said first opening feature and said second opening feature are positioned substantially between said midline and said distal end of said blade.

In another particular embodiment of the present invention a folding knife comprising: a blade having a first side, a second side, a spine, a distal end, a heel end, a midline positioned approximately half-way between said distal end and said heel end, and a predetermined thickness; a handle having a pivot pin, and a cavity defined between a first scale and a second scale, wherein said heel end of said blade is pivotally interconnected to said pivot pin, wherein said blade is movable from a closed position to an open position, and wherein said blade is at least partially disposed within said cavity when said blade is in said closed position; a first opening feature located on said first side of said blade, said first opening feature having a surface area; a second opening feature located on said second side of said blade, said second opening feature having a surface area; wherein said first opening feature and said second opening feature are positioned substantially between said midline and said distal end of said blade; wherein said first opening feature and said second opening feature are both located approximately the same distance from said distal end of said blade and said spine of said blade; wherein said first scale covers between about 10% to 50% of said surface area of said first opening feature; and wherein said second scale covers between about 10% to 50% of said surface area of said second opening feature.

In yet another particular embodiment of the present invention a folding knife comprising: a blade having a first side, a second side, a spine, a distal end, a heel end, a midline positioned approximately half-way between said distal end and said heel end, and a predetermined thickness; a handle having a pivot pin and a cavity, wherein said heel end of said blade is pivotally interconnected to said pivot pin, wherein said blade is movable from a closed position to an open position, and wherein said blade is at least partially disposed within said cavity when said blade is in said closed position; a first opening feature located on said first side of said blade, wherein said first opening feature is a depression having a depth; a second opening feature located on said second side of said blade, wherein said second opening feature is a depression having a depth; wherein said first opening feature and said second opening feature are positioned substantially between said midline and said distal end of said blade; and wherein said depth of said first opening feature is between about 5% and 20% of said predetermined thickness of said blade, and said depth of said second opening feature is between about 5% and 20% of said predetermined thickness of said blade, and wherein said first opening feature and said second opening feature are adapted for operable engagement with a user's fingers or thumb to promote movement between said closed position and said open position.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects should be understood to mean certain embodiments of the present invention and should not necessarily be construed as limiting all embodiments to a particular description. The present invention is set forth in various levels of detail in the Summary of the Invention as well as in the attached drawings and Detailed Description and no limitation as to the scope of the present invention is intended by either the inclusion or non-inclusion of elements, components, etc. in this Summary of the Invention. Additional aspects of the present invention will become more readily apparent from the Detailed Description particularly when taken together with the drawings.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

FIG. 1 is a perspective view of an embodiment of a folding knife with depressions in an open position;

FIG. 2 is a front elevation view of the folding knife of FIG. 1;

FIG. 3 is a top plan view of the folding knife of FIG. 1;

FIG. 4 is a front elevation view of the folding knife in FIG. 1 shown in a closed position;

FIG. 5 a perspective view of an embodiment of a folding knife with protrusions in an open position; and

FIG. 6 is a top plan view of the folding knife of FIG. 5.

To assist in the understanding of the embodiments of the present invention the following list of components and associated numbering found in the drawings is provided herein:

| Component No. | Component |
|---|---|
| 2 | Folding Knife |
| 4 | Blade |
| 6 | Cutting Edge |
| 8 | Spine |
| 10 | Thumb Serrated Portion |
| 12 | Aperture |
| 14 | Finger Serrated Portion |
| 16 | Choil |
| 18 | First Depression |
| 20 | Second Depression |
| 22 | Pivot Pin (Blade Pivot Point) |
| 24 | Back Spacer |
| 26 | First Scale |
| 28 | Second Scale |
| 30 | Pin |
| 32 | Pin |
| 34 | First Protrusion |
| 36 | Second Protrusion |
| 38 | Handle |
| 40 | Midline |

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

As described in detail below, various embodiments of the present invention include a novel folding knife blade comprising depressions, protrusions, and/or other opening features. The present invention has significant benefits across a broad spectrum of endeavors. It is the Applicant's intent that this specification and the claims appended hereto be accorded a breadth in keeping with the scope and spirit of the invention being disclosed despite what might appear to be limiting language imposed by the requirements of referring to the specific examples disclosed.

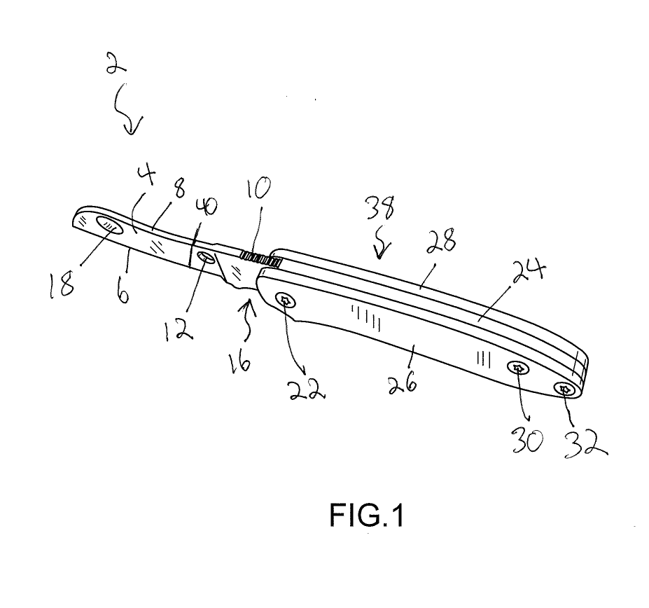

Referring now to the drawings, FIG. 1 shows a perspective view of one embodiment of a folding knife 2 in an open position. The folding knife 2 generally comprises a blade 4 that is rotatably interconnected to a handle 38. Additionally, the blade 4 includes a cutting edge 6, which is typically sharpened and opposite the spine 8, a thumb serrated portion 10, and an aperture 12. The thumb serrated portion 10 gives the user's thumb additional friction and resistance, which can enhance the user's grip when cutting, thrusting, and stabbing. One skilled in the art will appreciate that the blade 4 may comprise features such as bevels, serrations, or any other feature that is commonly included on the blade 4 of a folding knife 2.

The blade 4 is pivotable about a pivot pin 22 (also called a “blade pivot point” herein) allowing the blade 4 to be extended when the folding knife 2 is in an open position, folded when the folding knife 2 is in a closed position, and pivoted therebetween. Describing the blade 4 in an open and closed position and the folding knife 2 in an open and closed position both refer to the same positioning of the blade 4.

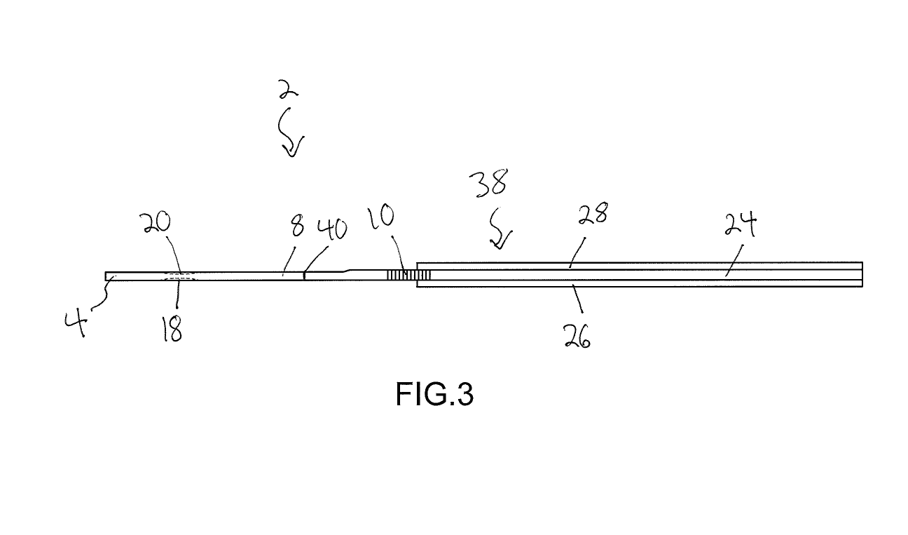

The folding knife 2 depicted in FIG. 1 comprises a first depression 18 and a second depression 20 (shown in FIG. 3). The depressions 18, 20 in this particular embodiment are located proximate a spine 8 of the blade 4 and substantially between a midline 40 and a distal end of the blade 4. However, in other embodiments the depressions 18, 20 may be positioned proximate to a cutting edge 6 of the blade 4 and/or substantially between the midline 40 and a heel end of the blade 4, which is the end of the blade 4 opposite the distal end of the blade 4. The depressions 18, 20 aid a user in pivoting the blade 4 as described herein. Further, in this particular embodiment of the invention, the aperture 12 positioned substantially between the midline 40 and the heel end of the blade 4.

The blade 4 and handle 38 may be shaped such that they form a choil 16 on the lower side of the folding knife 2. The choil 16 may assist the user in gripping the folding knife 2 and may be adapted to receive a user's fingers.

The handle 38 comprises extended members often referred to as scales 26, 28. The folding knife 2 depicted in FIG. 1 has a first scale 26 and a second scale 28. The first scale 26 and the second scale 28 provide the majority of the surface area that the user will grip with his or her hand. One skilled in the art will appreciate that a folding knife 2 is not limited to a two-scale configuration. In alternative embodiments, the handle 38 may comprise only one scale or member that provides a cavity or recess for the blade 4.

In the embodiment depicted in FIG. 1, a back spacer 24 is disposed between the first scale 26 and the second scale 28. The back spacer 24 provides depth to the handle 38 such that the blade 4 may be partially disposed within a cavity or recess in the handle 38 when the folding knife 2 is in the closed position. Further the back spacer 24 provides a stop surface upon which the blade 4 rests when the folding knife 2 is in the open position. The back spacer 24 provides a necessary obstacle to prevent the blade 4 from being driven upward when a significant force is applied to the cutting edge 6. One skilled in the art will appreciate other features that dictate the travel of the blade 4. For example, a stop pin could be used to prevent overtravel of the blade 4. Further, a lock pin may be used to lock and unlock the blade 4 to allow the blade 4 to pivot between the folding knife's 2 closed position and the folding knife's 2 open position.

A plurality of pins secures the various components of the folding knife 2. The pivot pin 22 secures the first scale 26, the second scale 28, and the heel end of the blade 4. As mentioned above, the blade 4 is rotatably interconnected to the handle 38, and the blade 4 pivots about the pivot pin 22. At the other end of the handle 38, two pins 30, 32 secure the first scale 26, the second scale 28, and the back spacer 24. One skilled in the art will appreciate various members that serve as a pin defined herein, including, but not limited to, rivets, nails, bolts, studs, screws, pegs, spikes, and tacs.

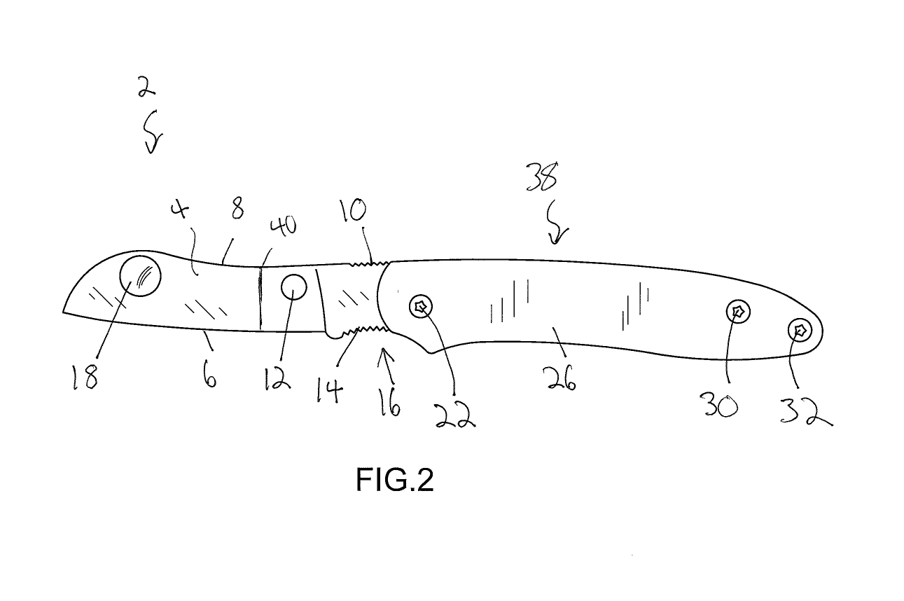

FIG. 2 shows a front elevation view of the folding knife 2 of FIG. 1. A finger serrated portion 14 is located on the lower portion of the blade 4. The shape of the finger serrated portion 14 and the shape of the handle 38 form the choil 16. Similar to the thumb serrated portion 10, the finger serrated portion 14 gives the user's fingers additional friction and resistance, which can enhance the user's grip when cutting, thrusting, and stabbing.

In some embodiments the blade 2 may comprise two or more depressions 18, 20 (shown in FIG. 3). Further, the depressions may come in a variety of shapes. The shape of the first depression 18 from the front elevation view is circular. One skilled in the art will appreciate that the shape of the depressions may be basic shapes such as triangles, squares, ovals, ellipses, rectangles, cylinders, etc. Further, the shape of the depressions may be amorphous, ergonomic, or any other shape that enhances a user's ability to pivot the blade 4.

FIG. 3 shows a top plan view of the folding knife 2 of FIG. 1. In one embodiment, the first depression 18 and the second depression 20 are located approximately opposite to each other. In other words, the first depression 18 and the second depression 20 are both located approximately the same distance from the distal end of the blade and approximately the same distance from the spine 8 of the blade 4. The inclusion of two depressions allows a user to utilize two fingers to pivot the blade 4.

One skilled in the art will appreciate a variety of depressions located in a variety of positions on the blade 4. For example, the first depression 18 and the second depression 20 need not be located approximately opposite to each other. Asymmetrical configurations of the depressions may be advantageous depending on the preference of the user or other characteristics of the user and/or the folding knife. Further, it may be advantageous to have a different number of depressions. For example, one side of the blade 4 may have multiple depressions, and the other side of the blade 4 maybe have one, multiple, or no depressions. Further, depressions may be used in combination with protrusions or any other opening feature. For example, a depression may be located just beneath a protrusion to improve the effectiveness of the folding knife.

The depth of the depressions 18, 20 may be expressed in terms of the thickness of the blade 4. In various embodiments, the depth of the first depression 18 and/or second depression 20 is approximately less than 90% of the thickness of the blade 4. In preferred embodiments, the depth of the first depression 18 and/or second depression 20 is approximately less than 50% of the thickness of the blade 4. In a further preferred embodiment, the depth of the first depression 18 and/or second depression 20 is approximately 30% of the thickness of the blade 4. In a most preferred embodiment, the depth of the first depression 18 and/or second depression 20 is between about 5% and 20% of the thickness of the blade 4. In some embodiments of the present invention the thickness of the blade 4 is not constant between the heel end of the blade 4 and the distal end of the blade 4. In such embodiments, the thickness of the blade 4 where the depression is located should be used when calculating the depth of the first depression 18 and/or second depression 20 relative to the thickness of the blade 4.

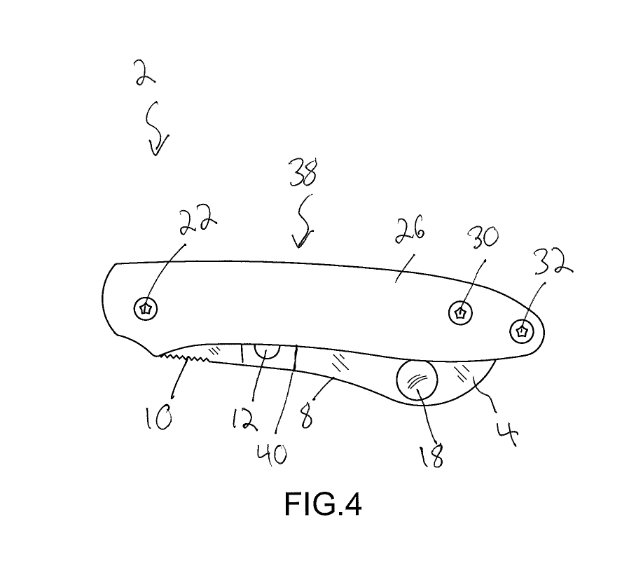

FIG. 4 shows the folding knife 2 of FIG. 1 in the closed position. In the closed position, the blade 4 is pivoted and folded such that it is partially disposed with the cavity or recess in the handle 38. Thus, the cutting edge 6 (not shown) of the blade 4 is concealed, and the folding knife 2 may be safely transported. In this particular embodiment of the present invention, the first depression 18 has a surface area and is partially disposed within the cavity or recess of the handle 38, which is partially defined by the first scale 26. In some embodiments, the first scale 26 does not cover any surface area of the first depression 18. In various embodiments, the first scale 26 covers less than 90% of the surface area of the first depression 18. In preferred embodiments, the first scale 26 covers less than 50% of the surface area of the first depression 18. In a further preferred embodiment, the first scale 26 covers less than 10% of the surface area of the first depression 18. In a most preferred embodiment, the first scale covers between about 10% and 50% of the surface area of the first depression 18. Although not pictured, the second depression 20, a first protrusion 34, and a second protrusion 36 may comprise a surface area and may be similarly disposed about the cavity or recess of the handle 28 as described above.

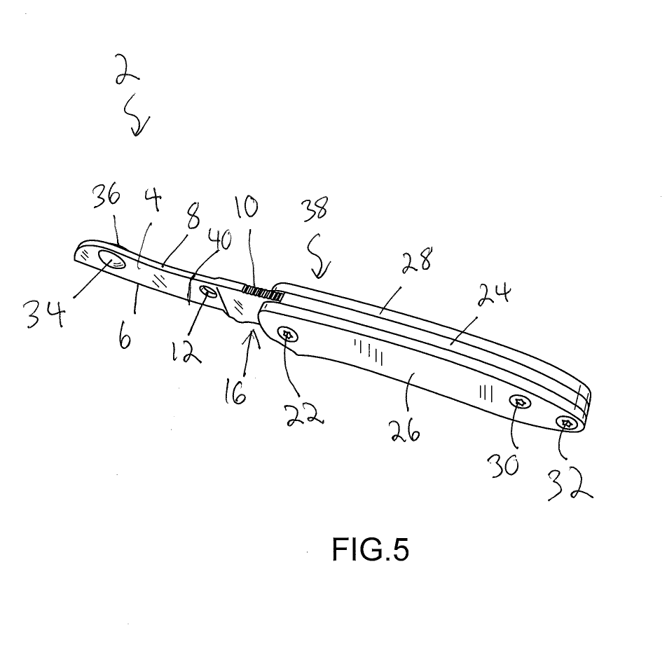

FIG. 5 shows a perspective view of a second embodiment of a folding knife 2 in an open position. The folding knife 2 depicted in FIG. 5 comprises the first protrusion 34 and the second protrusion 36 instead of depressions. The protrusions 34, 36 in this particular embodiment are located proximate a spine 8 of the blade 4 and substantially between the midline 40 and the distal end of the blade 4. These protrusions aid a user in pivoting the blade 4 from a closed position to an open position.

The protrusions may come in a variety of shapes. The shape of the first protrusion 34 and the second protrusion 36 depicted in FIG. 5 is circular. One skilled in the art will appreciate that the shape of the protrusions may be basic shapes such as triangles, squares, ovals, ellipses, rectangles, cylinders, etc. Further, the shape of the protrusions may be amorphous, ergonomic, or any other shape that enhances a user's ability to pivot the blade 4.

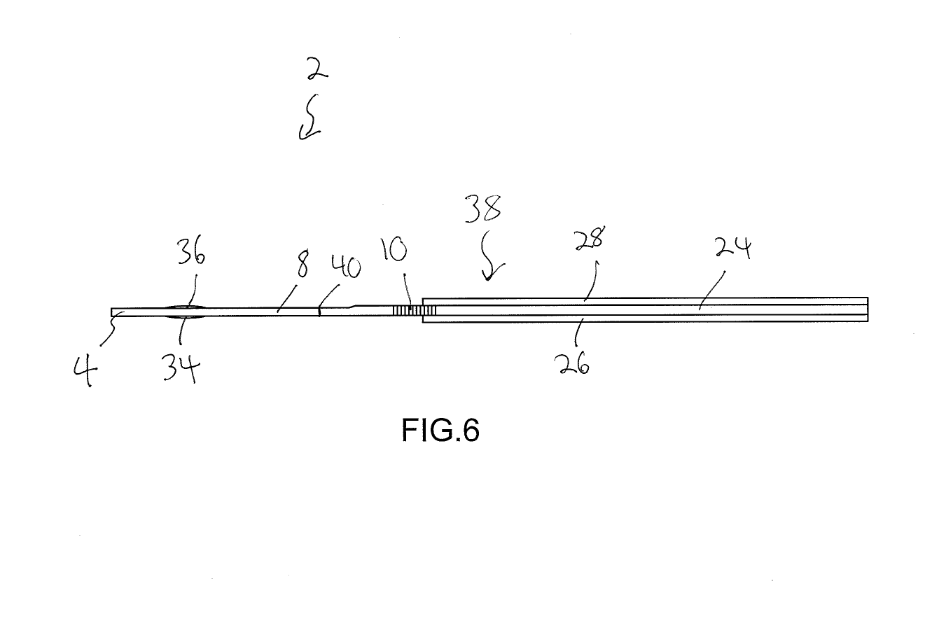

FIG. 6 shows a top plan view of the folding knife 2 of FIG. 5. The first protrusion 34 and the second protrusion 36 are located approximately opposite each other. In other words, the first protrusion 34 and the second protrusion 36 are both located approximately the same distance from the distal end of the blade and approximately the same distance from the spine 8 of the blade 4. The inclusion of two protrusions allows a user to utilize two fingers to pivot the blade 4.

One skilled in the art will appreciate a variety of protrusions located in a variety of positions on the blade 4. For example, the first protrusion 34 and the second protrusion 36 need not be located proximate to each other. Asymmetrical configurations of the protrusions may be advantageous depending on the preference of the user or other characteristics of the user. Further, it may be advantageous to have any number of protrusions, from one protrusion to more than two protrusions. For example, one side of the blade 4 may have one, multiple, or no protrusions. Further, protrusions may be used in combination with depressions or any other opening feature. For example, a depression may be located just beneath a protrusion to improve the effectiveness of the folding knife.

The thickness of the protrusions 34, 36 may be expressed in terms of the thickness of the blade 4 where the protrusions 34, 36 are located. In various embodiments, the thickness of the first protrusion 34 and/or second protrusion 36 is approximately less than 300% of the thickness of the blade 4. In preferred embodiments, the thickness of the first protrusion 34 and/or second protrusion 36 is approximately less than 100% of the thickness of the blade 4. In a further preferred embodiment, the thickness of the first protrusion 34 and/or second protrusion 36 is approximately 30% of the thickness of the blade 4. In a most preferred embodiment, the thickness of the first protrusion 34 and/or second protrusion 36 is between about 100% and 300% of the thickness of the blade 4. In some embodiments of the present invention the thickness of the blade 4 is not constant between the heel end of the blade 4 and the distal end of the blade 4. In such case, the thickness of the blade 4 where the protrusion is located should be used when calculating the thickness of the first protrusion 34 and/or second protrusion 36 relative to the thickness of the blade 4.

Further, one skilled in the art will appreciate opening features beyond depressions and protrusions that aid a user in opening a folding knife. For example, opening features such as slots, holes, openings, apertures, cavities, gaps, projections, protuberances, bumps, knobs, and/or studs may also aid a user in opening a folding knife.

Further yet, one skilled in the art will appreciate depressions, protrusions, or other opening features that not only aid a user in opening a folding knife, but other devices. The devices may include, but are not limited to, saws, multi-tools, shears, awls, or any other device that is movable from an open and extended position to a closed position.

The phrases “at least one”, “one or more”, and “and/or”, as used herein, are open-ended expressions that are both conjunctive and disjunctive in operation. For example, each of the expressions “at least one of A, B, and C”, “at least one of A, B, or C”, “one or more of A, B, and C”, “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification, drawings, and claims are to be understood as being modified in all instances by the term “about.”

The term “a” or “an” entity, as used herein, refers to one or more of that entity. As such, the terms “a” (or “an”), “one or more” and “at least one” can be used interchangeably herein.

The use of “including,” “comprising,” or “having,” and variations thereof, is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts, and the equivalents thereof, shall include all those described in the summary of the invention, brief description of the drawings, detailed description, abstract, and claims themselves.

The foregoing description of the present invention has been presented for illustration and description purposes. However, the description is not intended to limit the invention to only the forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Consequently, variations and modifications commensurate with the above teachings and skill and knowledge of the relevant art are within the scope of the present invention. The embodiments described herein above are further intended to explain best modes of practicing the invention and to enable others skilled in the art to utilize the invention in such a manner, or include other embodiments with various modifications as required by the particular application(s) or use(s) of the present invention. Thus, it is intended that the claims be construed to include alternative embodiments to the extent permitted by the prior art.

What is claimed is:

1. A folding knife, comprising:
a blade having a first side, a second side, a spine, a distal end, a heel end, and a midline positioned approximately half-way between said distal end and said heel end;
a handle having a pivot pin and a cavity, wherein said heel end of said blade is pivotally interconnected to said pivot pin, wherein said blade is movable from a closed position to an open position, and wherein said blade is at least partially disposed within said cavity when said blade is in said closed position;
a first opening feature located on said first side of said blade;
a second opening feature located on said second side of said blade; and
wherein said first opening feature and said second opening feature are positioned substantially between said midline and said distal end of said blade.

2. The folding knife of claim 1, wherein said first opening feature is at least one of a depression and a protrusion.

3. The folding knife of claim 1, wherein said second opening feature is at least one of a depression and a protrusion.

4. The folding knife of claim 1, wherein said first opening feature and said second opening feature are both located approximately the same distance from said distal end of said blade and said spine of said blade.

5. The folding knife of claim 1, wherein said first opening feature is at least partially disposed within said cavity when said blade is in said closed position.

6. The folding knife of claim 1, wherein said second opening feature is at least partially disposed within said cavity when said blade is in said closed position.

7. The folding knife of claim 1, wherein at least one of said first opening feature and said second opening feature has at least one of a circular shape, an elliptical shape, a rectangular shape, and a triangular shape.

8. The folding knife of claim 1, wherein said blade comprises an aperture positioned substantially between said midline and said heel end of said blade.

9. The folding knife of claim 1, further comprising a third opening feature located on at least one of said first side of said blade and said second side of said blade.

10. The folding knife of claim 9, further comprising a fourth opening feature located on at least one of said first side of said blade and said second side of said blade.

11. The folding knife of claim 10, wherein at least one of said third opening feature and said fourth opening feature has a circular shape, an elliptical shape, a rectangular shape, and a triangular shape.

12. A folding knife, comprising:
a blade having a first side, a second side, a spine, a distal end, a heel end, a midline positioned approximately half-way between said distal end and said heel end, and a predetermined thickness;
a handle having a pivot pin, and a cavity defined between a first scale and a second scale, wherein said heel end of said blade is pivotally interconnected to said pivot pin, wherein said blade is movable from a closed position to an open position, and wherein said blade is at least partially disposed within said cavity when said blade is in said closed position;
a first opening feature located on said first side of said blade, said first opening feature having a surface area;
a second opening feature located on said second side of said blade, said second opening feature having a surface area;
wherein said first opening feature and said second opening feature are positioned substantially between said midline and said distal end of said blade;
wherein said first opening feature and said second opening feature are both located approximately the same distance from said distal end of said blade and said spine of said blade;
wherein said first scale covers between about 10% to 50% of said surface area of said first opening feature; and
wherein said second scale covers between about 10% to 50% of said surface area of said second opening feature.

13. The folding knife of claim 12, wherein said predetermined thickness of said blade is constant between said distal end of said blade and said heel end of said blade.

14. The folding knife of claim 12, wherein said first opening feature is a depression having a predetermined depth, and said second opening feature is a depression having a predetermined depth.

15. The folding knife of claim 14, wherein said depth of said first opening feature is between about 5% and 20% of said predetermined thickness of said blade.

16. The folding knife of claim 14, wherein said depth of said second opening feature is between about 5% and 20% of said predetermined thickness of said blade.

17. The folding knife of claim 12, herein said first opening feature is a protrusion having a predetermined thickness extending outwardly from said first side of said blade, and said second opening feature is a protrusion having a predetermined thickness extending outwardly from said second side of said blade.

18. The folding knife of claim 17, wherein said predetermined thickness of said first opening feature is between about 100% and 300% of said predetermined thickness of said blade.

19. The folding knife of claim 17, wherein said predetermined thickness of said second opening feature is between about 100% and 300% of said predetermined thickness of said blade.

20. A folding knife, comprising:
a blade having a first side, a second side, a spine, a distal end, a heel end, a midline positioned approximately half-way between said distal end and said heel end, and a predetermined thickness;
a handle having a pivot pin and a cavity, wherein said heel end of said blade is pivotally interconnected to said pivot pin, wherein said blade is movable from a closed position to an open position, and wherein said blade is at least partially disposed within said cavity when said blade is in said closed position;
a first opening feature located on said first side of said blade, wherein said first opening feature is a depression having a depth;
a second opening feature located on said second side of said blade, wherein said second opening feature is a depression having a depth;
wherein said first opening feature and said second opening feature are positioned substantially between said midline and said distal end of said blade; and
wherein said depth of said first opening feature is between about 5% and 20% of said predetermined thickness of said blade, and said depth of said second opening feature is between about 5% and 20% of said predetermined thickness of said blade, and wherein said first opening feature and said second opening feature are adapted for operable engagement with a user's fingers or thumb to promote movement between said closed position and said open position.
